(19) United States
(12) Patent Application Publication
(10) Pub. No.: US 2008/0108434 A1
(43) Pub. Date: May 8, 2008

(54) INTERNET ENABLED REMOTE PLAY OF INTERACTIVE MECHANICAL AMUSEMENT GAMES OF SKILL

(76) Inventors: Kerry Mann, Carpineria, CA (US); Patrick Gilliland, Santa Barbara, CA (US)

Correspondence Address: FELIX L. FISCHER, ATTORNEY AT LAW, 1607 MISSION DRIVE, SUITE 204, SOLVANG, CA, 93463, US

(21) Appl. No.: 11/556,162

(22) Filed: Nov. 2, 2006

(51) Int. Cl. G06F 17/00

(52) U.S. Cl. 463/42

(57) ABSTRACT

A system for remotely playing an interactive mechanical amusement game of skill incorporating a manual input device, game console or personal computer and display, a game console or personal computer application software, internet connection and data exchange via internet protocol, a web hosting server and application software which controls access to the interactive mechanical amusement games of skill and otherwise facilitates play, a local area network for connecting various interactive mechanical amusement games of skill, and various interactive mechanical amusement games of skill, each adapted for remote play via internet connection and internet protocol and each capable of providing visual and/or audio feedback to a player remotely via internet connection and internet protocol.

### FIELD OF THE INVENTION

This invention relates generally to the field of interactive mechanical amusement games of skill such as those typically found in an amusement arcade, and web based interactive internet based games and, more particularly, to a system for interactively playing mechanical amusement games of skill remotely via internet connection.

### BACKGROUND OF THE INVENTION

At present interactive mechanical amusement games of skill are played physically at the site where the game is located. Computerized games are available using customized software applications which allow players to interact and compete in their games over a great distance using the internet. These computerized games use a mathematical algorithm to define the game. These computerized games require skill to master, but in any case, one is playing against a computer program or against a skilled opponent. Many people prefer the opportunity to match their skills against a game in which they must overcome the challenges posed by the physical attributes of mechanical skill games. There are many mechanical amusement skill games such as:

Skeeball, Bowling, Football Toss, Baseball Throw, Basketball Throw, Pinball, Virtual Golf, The Fishing Game and The Crane (claw) Game.

Exemplary games are defined as follows:

Skeeball—A very old carnival game. Players roll wooden balls down a wood tray over a ramp onto the rings on a backboard. Each ring is worth different points with the small center being valued at 50 pts. The goal is to get a score high enough to win prizes.

Bowling—This mechanical version of the real thing uses a puck instead of a bowling ball. The pins hang down over relays that by hitting in certain combinations mimic real bowling. There are several different game modes in which up to 4 players can participate.

The Fishing Game—This mechanical version of the real game uses a suspended magnetic bait instead of a real hook. The magnetic bait hangs down over the mechanical fish with their mouths open. The magnetic bait then interacts with a magnet in the fish's mouth, the magnets connect, and the fish is picked up. Each fish is worth different points. The game skill requirement is derived from placement of the suspended magnetic bait to “catch” the desired fish to accumulate points. The base where the fish are positioned is circular and is free to rotate. This gives the player the challenge of fishing for the fish.

The Crane (claw) Game—This game uses a joystick to control lateral movement of a mechanical crane in which the player attempts to position the crane, drop the claw, and grab stuffed animals and other prizes in a glass box. Usually one play per credit, the user moves the joystick within a time limit and presses a button to drop the claw-like attachment into the bin. The machine then automatically closes it's claw, raises it and moves back into a stationary position over a chute. If any prize is grabbed it gets dropped in the chute for the player to retrieve.

Because of the wide availability of personal computers, and the preference of many people to play interactive mechanical amusement games of skill, it is therefore desirable to have interactive mechanical amusement games of skill adapted such that they may be played via the internet. This will allow many people to play these interactive mechanical amusement games of skill who do not have the opportunity to play these games in their local neighborhoods, or who do not have the personal mobility to travel to the arcades housing the interactive mechanical amusement games of skill.

### SUMMARY OF THE INVENTION

An interactive mechanical amusement game of skill is adapted for play via the internet where the player plays from his personal computer (PC) or game console using a joystick, pressable buttons, mouse, trackball, touchpad, or other manual controls to operate the mechanical amusement game remotely over the internet. Information may be fed back to the player from video cameras, bell sounds, flashing lights, or other devices. The interactive mechanical amusement games of skill may include Skeeball, Bowling, The Crane, Pinball, Football Toss, and others.

A system for remotely playing an interactive mechanical amusement game of skill incorporating the invention includes a game console having an internet connection and an input device for generating a command sequence and an activate signal. A web server is connected to the internet and incorporates means to receive and transmit the command sequence and the activate signal. An interactive mechanical amusement game of skill is located at a remote site and connected to the web server. The game incorporates signal conditioning to receive the command sequence and the activate signal transmitted by the web server and provide compatible signals to a first mechanical actuation system responsive to the command sequence and a second mechanical actuation system responsive to the activate signal. Video feedback is provided from the remote game to the game console for interaction by the player.

### BRIEF DESCRIPTION OF THE DRAWINGS

These and other features and advantages of the present invention will be better understood by reference to the following detailed description when considered in connection with the accompanying drawings wherein:

FIG. 1 is block diagram showing a complete system embodying the present invention;

FIG. 2 is a block diagram of The Crane element of FIG. 1, associated electronic/mechanical interface, video cameras, and prizes;

FIG. 3 is a block diagram of a Skeeball game element of FIG. 1 and associated electronic/mechanical interface and video cameras;

FIG. 4 is a block diagram of a Bowling game element of FIG. 1 and associated electronic/mechanical interface and video cameras;

FIG. 5 is a block diagram of the Web Server Computer employed in an exemplary system embodying the invention showing the internal functions and external connections;

FIG. 6 is a flow chart of a software implementation of operational setup of the game console in the system employing the present invention; and,

FIG. 7 is a flow chart of the system interaction for control of the remote game by the game console.

### DETAILED DESCRIPTION OF THE INVENTION

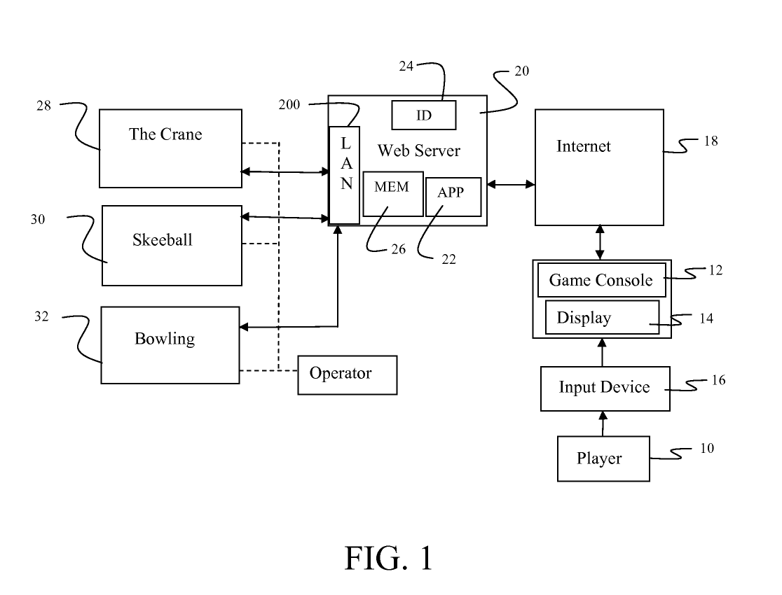

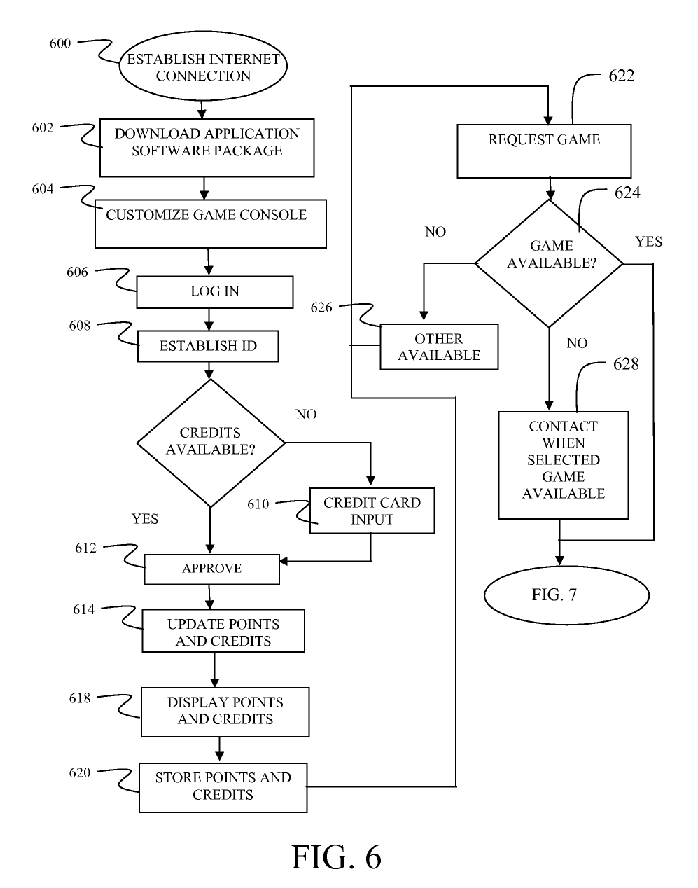

Referring to FIGS. 1 and 6, a player 10 sits at an operating game console 12 or personal computer having a display 14 and an input device 16, to be described in greater detail subsequently. The player establishes 600 an internet connection 18, and contacts a web host server 20 using the proper IP address. As shown in FIG. 6, the prospective player then downloads 602 an application software package 22 from the web host server which is delivered via internet and is used to customize the game console or adapt his/her personal computer 604 to the task of remotely playing interactive mechanical amusement games of skill. The player then “logs in” 606 to the site and the web server identifies established credits 608 or submits credit card information 610 through a billing and ID authorization transaction system 24 to pay for the session. Once approved 612, the player's points total and number of game credits is updated electronically by the server 614, displayed on the console display 618 and stored 620 in a server memory 26. The player then requests permission to play a particular interactive mechanical amusement game of skill 622 such as The Crane 28, Skeeball 30 or Bowling 32. If the chosen game is unavailable 624, the player may be directed towards other available games 626, or will be contacted by the web hosting server once the game becomes available 628.

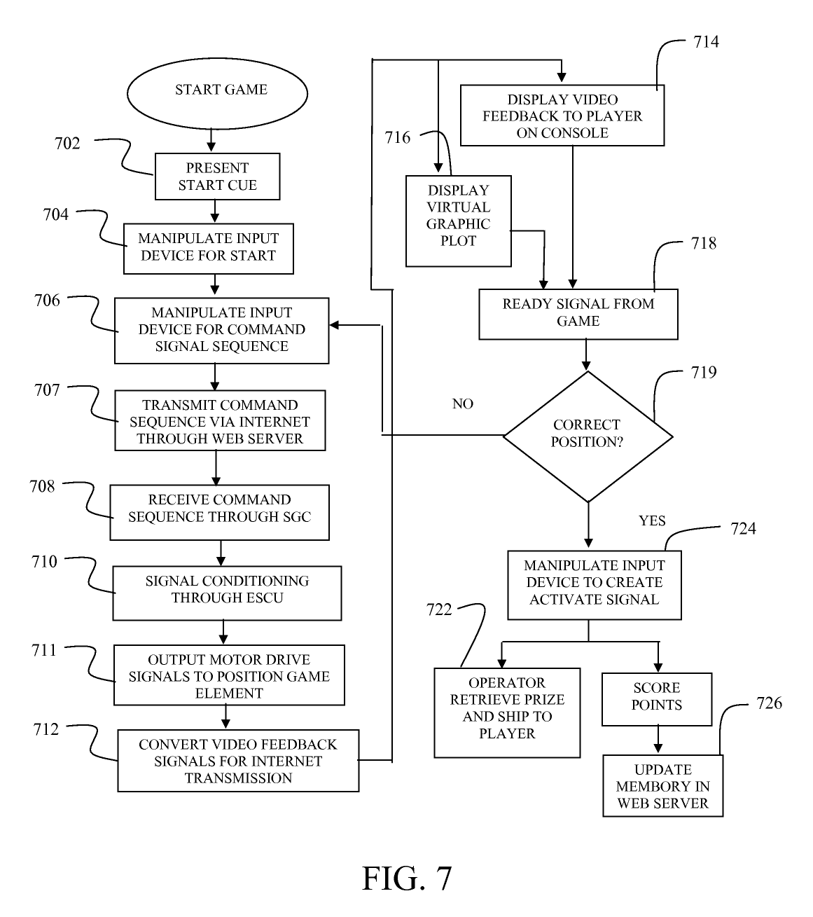

Operation of the remotely located game of skill is accomplished via the internet The player views the game console display or computer display in front of him/her and waits for a start cue 702 as shown in FIG. 7, which tells him the skill game is ready to play. The start cue can be a visual graphic such as an icon, and/or a bell sound, whistle, or other sound specific to the particular interactive mechanical amusement game of skill which the player has chosen to play. The player then uses the input device which in alternative embodiments is a joystick, pressable button or buttons, mouse, trackball, touchpad, or other pressure sensitive devices or combinations thereof to start the game 704. The input device then communicates the input from the player to the game console or personal computer as a set of digital commands or a command sequence 706. Residing on the game console or personal computer is the downloaded application software program which converts the command signals into an internet protocol (IP) data stream and adapts the resulting IP data stream for transmission 707 over telephone lines or coaxial television cable. In alternative embodiments, the personal computer provides a terminal to play the game using an internet browser program and standard input devices, such as a pressure sensitive touchpad and mouse, wherein all operating software is resident on the web hosting server.

Once the IP data stream is transmitted to the internet portal, the internet then routes the IP data stream to the web host computer server which receives the data stream and passes the player's command signal to the proper interactive mechanical amusement game of skill. The data stream is passed to the desired interactive mechanical amusement game of skill via a local area network (LAN) such as Ethernet, Token Ring, FDDI, Fibre Channel, Firewire®, IEEE1394, or USB connection. Other LAN structures may be used without compromising the unique features of the invention.

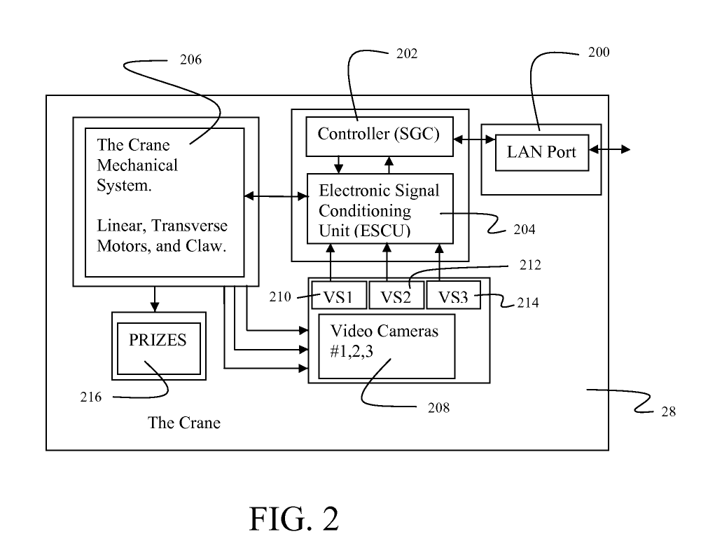

The player's command signal then is received via the LAN connection by the selected interactive mechanical amusement game of skill. Using the Crane Game of FIG. 2 as an example in conjunction with the operational elements of FIG. 7, the digital data stream from the LAN port 200 is then received 708 by the Skill Game Controller (SGC) 202, which passes 710 the digital command sequence to the electrical signal conditioning unit (ESCU) 204. Depending on the embodiment, the ESCU converts the signal format from digital to analog and/or from analog to digital if necessary, amplifies the voltage, increases the current driving capability, or makes other adaptations necessary. In this manner, the electrical signal conditioning unit (ESCU) and the skill game controller (SGC) work cooperatively to create a proper driving signal 711 for driving the motors 206 of The Crane, for example, in both the linear and transverse directions, and controls the sequence and timing of the game. The Crane game employs video cameras 208 mounted in the box housing the crane element to provide visual feedback to the player as to the position of The Crane claw. These video feedback signals VS 1210, VS2 212, and VS3 214, are converted 712 by the ESCU as required and routed through the SGC for transmission to the player via LAN to the web hosting server, then to the internet as IP data streams, and finally to the user via telephone lines or coaxial television cable. Other Crane game status indicators are passed to the player in like manner; their signal format converted to an appropriate digital signal by the ESCU and passed through the Skill Game Controller to the LAN and then back to the remote player. The graphic display on the player's game console or personal computer will then display selected video images 714 so the player can make an informed decision about where to position The Crane using his joystick, mouse, trackball, touchpad, or other pressure sensitive input device. Display of the crane position as a virtual graphic plot on the console monitor provides the player with exact positioning of the crane 716 in alternative embodiments. Once the “ready” signal is displayed by the game console 718, the player knows The Crane has stopped traversing. The player then makes a decision 719 to push a button or click a mouse to create an activate signal 720 to drop the claw, or continue positioning The Crane.

Accompanying the video images is an icon which tells the player the crane has stopped moving and is ready for further input. This “ready” cue is essential due to the variable time delays experienced by signals traveling over the internet. The timer on The Crane game will count only the time used by the player in making decisions and manipulating the input devices against the nominal 20 second limit for the player's full game sequence (i.e., the cumulative time between “ready” cues and when the player completes a sequence of control commands to the game). Once the player initiates the “drop” sequence from his/her game console, the signal travels to The Crane game in the described manner, and The Crane game completes the sequence of claw drop, grab, and deposit of a prize 216 in the chute in the same manner as when the player is instant in the same location as The Crane game. The Crane game operator will then remove the captured prize from the chute, package it, and send it to the player via mail or parcel service 722. Additionally, it is foreseen that a player may prefer to select to have points awarded for a captured prize 724. A system for totaling and maintaining the player's points is provided by the application software and stored in the web server memory 726. Points are accumulated and traded for larger prizes, or for additional game credits. Other adaptations to The Crane game may be necessary to optimize The Crane game performance and enhance the player's experience of playing The Crane game remotely via internet connection.

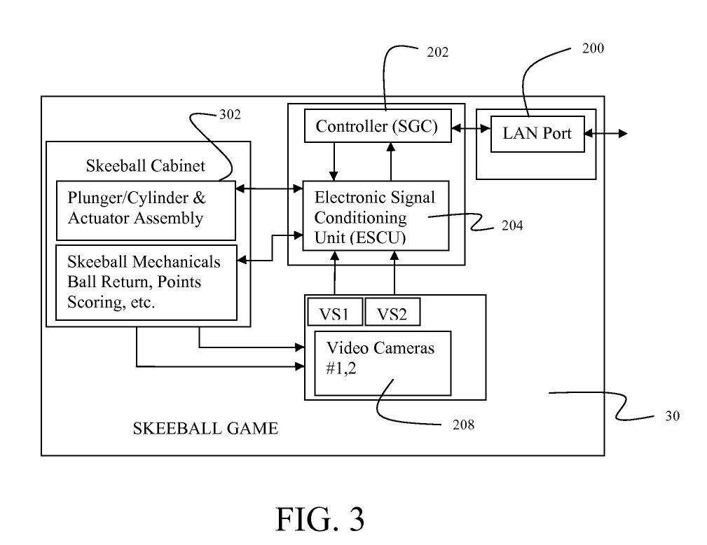

Similarly, a Skeeball game may be played remotely via internet connection, but with several additional adaptations required. Referring to FIG. 3, the Skeeball game must have additional elements to adapt the game for remote play via the internet. An electromechanical device for propelling and directing the ball such as plunger/cylinder & actuator assembly 302 must be fitted to the Skeeball cabinet and connected to the electrical signal conditioning unit (ESCU). A simple spring loaded plunger having a concave surface at a first end for engaging the Skeeball ball and mounted within a cylinder having a breech and an electromagnetic solenoid actuator or linear motor connected to the plunger second end are used for the Skeeball game to propel the ball in the embodiment shown. A pivot and motorized bidirectional rotation stage mounted below the plunger assembly will allow for directional control of the ball, and a feed mechanism for placing the ball in the plunger assembly cylinder breech is situated at one side of the cylinder breech. A first one of the video cameras delivers a wide angle shot of the complete Skeeball playing area. A second video camera delivers a close up shot of the target and scoring area.

To mimic the act of bowling the ball usually done by the player's arm, the pivot and rotational stage start at rest position with the plunger and cylinder nearly in line with the direction of bowling. The actual start position angle must be counter-clockwise several degrees of the center axis of the bowling surface, defined as zero (0) degrees. This negative angular bias will allow the bowler to miss to the left as well as to the right, and give a true freedom to the bowler to place the ball anywhere in the scoring area. As with the Crane, once the remote player clicks a mouse or presses a button providing the command sequence 706, the ECSU provides a driving signal 707 and the play sequence begins with the pivot and rotation stage starting a slow turn clockwise. This clockwise rotation is analogous to the backswing of a bowler's arm. As the backswing starts, the plunger is also ratcheted backwards against the load spring. The longer the player holds down the mouse button, the greater the rotation, or length of the backswing, and the greater the compression of the plunger load spring. Once the mouse button is released, the pivot and rotation stage begin an angular rotation counter-clockwise at a rate slightly faster than the backswing. A second click of the mouse button provides an activate signal 720 releasing the plunger and the full force of the compressed load spring propels the ball forward at whatever angle to the axis of bowling (zero degrees) the rotational stage has returned.

The maximum travel clockwise is slightly less than the 90 degree position relative to the bowling axis centerline (zero degrees). The maximum plunger spring compression is also achieved at the maximum backswing. If the player holds the mouse down after the first click long enough, and allows the rotation to reach its maximum backswing and maximum spring compression without releasing the mouse button, the Skeeball game console application software will intervene and the rotation stage will automatically reverse and begin rotating counter-clockwise without a player command. The player may still control the point of release by a second click of the mouse button. Because of the variable delays in transmitting command signals via the internet, the play sequence as described above may not be carried out in real time with video feedback images. In one embodiment to accommodate this delay, the “first click”, “hold”, and “second click” are entered by the player while a graphic display on the game console indicates the virtual position of the rotation stage and the compression level of the plunger load spring. The actual bowling sequence will then be carried out in real time, once the player's complete command sequence and timing has been entered and forwarded to the Skeeball game. Video images showing the results will be returned to the player in the most timely manner possible. Some buffering of the returned video signals may be necessary to ensure a halt-free viewing, up to and including delivery of a complete video data file for replay. In this manner, a dedicated Skeeball bowler may practice his sport remotely via internet connection, and hone his skills for match play against other remote players, and do so with a minimum of equipment which is normally provided as a standard option on many personal computers.

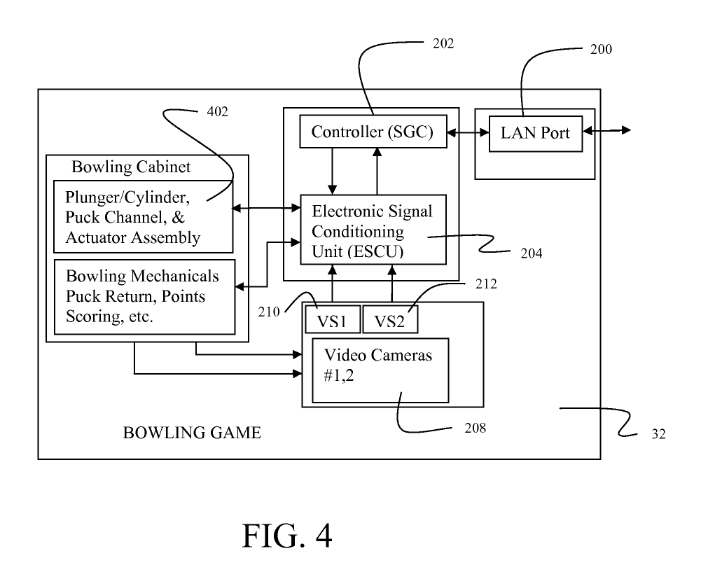

Referring to FIG. 4, the Bowling interactive mechanical amusement game of skill must be adapted in a similar fashion as the Skeeball game of the previous example, but the plunger and cylinder arrangement 402 must be modified. The plunger must have its first end which contacts the puck shaped to properly control the puck. This may be achieved by attaching a “T” shaped bar with one concave surface to the end of the plunger. The cylinder which houses the plunger must have at its end which receives the puck a channel shaped with a rectangular cross-section rather than the circular channel of the Skeeball game of the previous example. A breech in the side of this rectangular channel will facilitate loading of the puck by the puck loading mechanism. As with the Skeeball example, a motorized bidirectional rotation stage mounted below the plunger assembly will allow for directional control of the puck. The manner of play by a remote player is identical with the Skeeball game, though the results are borne out by puck, pin, and relay, as opposed to the ball, ramp, and target circle of the Skeeball game.

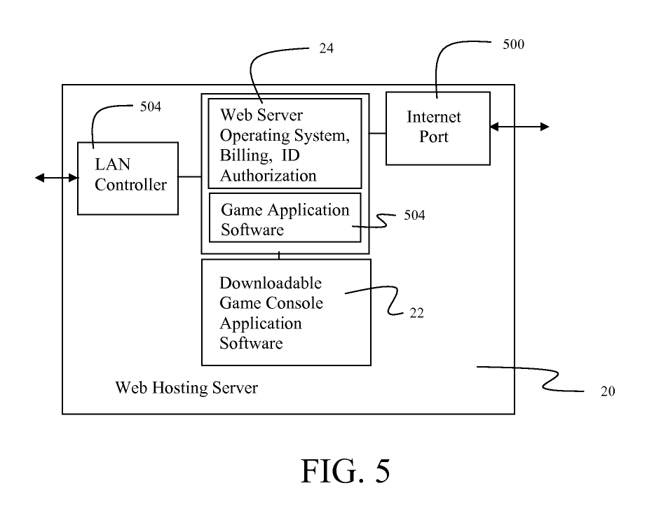

Referring to FIG. 5, a web hosting server is shown which performs the functions necessary to the remote play of interactive mechanical amusement games of skill via internet connection. A modem 500 for connecting to telephone lines or a data cable connection and cable modem provides connectivity to the internet Residing on the web hosting server is a downloadable application software package 22 which is downloadable via the internet to the player and is used to adapt the player's game console or PC for the purpose of remotely playing interactive mechanical amusement games of skill via internet connection. The application software also allows a player to play with a browser and standard PC input devices, such as a pressure sensitive touchpad and mouse. This software also passes the player's commands to the respective game and returns to the player video images, visual cues, bell sounds, whistles, and/or other skill game feedback signals necessary for the player to control the interactive mechanical amusement game of skill.

The web hosting server also runs an application software 502 which supervises the entire site and provides information on the availability of games to the players, maintains their game credits and point totals, controls access to the site, performs credit card authorization and billing, and connects the player to the proper interactive mechanical amusement game of skill once a selection is made. The web host server also provides a LAN controller 504 for communicating with all the interactive mechanical amusement games of skill connected to its multiple ports.

For the embodiment described herein, the games may be sited within a warehouse or other remote location, or may be the very same games installed in an amusement arcade or bowling alley annex. With the ability to remotely operate the interactive mechanical amusement games of skill, owners of these machines incorporating this invention may now possibly be able to operate them profitably 24 hours a day.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A system for remotely playing an interactive mechanical amusement game of skill comprising:
a game console having an internet connection and means for generating a command sequence and an activate signal;
a web server connected to the internet and having means to receive and transmit the command sequence and the activate signal;
an interactive mechanical amusement game of skill at a remote site connected to the web server and having means to receive the command sequence and the activate signal transmitted by the web server, a first mechanical actuation system responsive to the command sequence and a second mechanical actuation system responsive to the activate signal.

2. A system as defined in claim 1 wherein the game console includes a display.

3. A system as defined in claim 2 further having a visual feedback system from the mechanical amusement game of skill connected to the web server and through the internet to the game console for visual feedback cues.

4. The system of claim 1 wherein the mechanical amusement game of skill is The Crane.

5. The system of claim 1 wherein the mechanical amusement game of skill is Skeeball.

6. The system of claim 1 wherein the mechanical amusement game of skill is Bowling.

7. The system of claim 1 wherein the means to receive the command sequence and activate signal is a local area network data port and an electronic signal conditioning unit for converting the command sequence and activate signal into electrical outputs useful in initiating mechanical game of skill play sequences.

9. A system as defined in claim 2 further comprising an application software package loadable in the game console which provides a virtual image for the display for enabling the player to appropriately gauge the required command sequence and proper activation signal timing to operate the amusement game.

10. An interactive mechanical amusement game of skill for remote play comprising:
a remotely located interactive mechanical game of skill having a game controller connected to a local area network, the game controller adapted to receive a command signal sequence and an activate signal, the game of skill further incorporating a signal conditioning unit for converting the command signal sequence and activate signal to drive signals for mechanical elements of the game;
a web server connected to the game controller via the local area network.

11. An interactive mechanical amusement game as defined in claim 10 further comprising:
at least one video camera for generating visual feedback cues mounted for viewing the mechanical game of skill and connected through the game controller and local area network to the web server.

12. An interactive mechanical amusement game as defined in claim 11 wherein the remote control means comprises a game console and further comprising:
a game application software package downloadable from the web server for use by the game console for encoding the command signal sequence and the activate signal and visual feedback cues to a game console display

13. A method for remotely operating an interactive mechanical game of skill comprising the steps of:
providing a game console having an input device and a display;
connecting the game console to the internet through a web server;
connecting at least one remotely located mechanical game of skill to the web server through a local area network;
communicating the input from a player to the game console input device as a command sequence;
transmitting the player's command sequence through the web server via the LAN to the interactive mechanical amusement game of skill;
converting the signal format to create a proper driving signal for actuation of the mechanical game of skill;
providing visual feedback to the player from a video camera of the positioning of the mechanical game of skill;
displaying a “ready” signal;
determining if additional command sequence input is received;
if not, receiving an activate signal created by the user on the input device and;
activating the mechanical game.

14. A method as defined in claim 13 wherein the step of connecting the game console to the internet through a web server comprises the steps of:
downloading an application software package from the web host server customizing the game console with the application software package to the task of remotely playing interactive mechanical amusement games of skill;
logging in to the web server and establishing credits through a billing and ID authorization transaction system;
approving the log in;
updating and displaying a points total and number of game credits storing the points total and number of game credits in a server memory;
receiving a request to play a particular interactive mechanical amusement game of skill.

15. A method as defined in claim 14 wherein more than one remotely located mechanical game of skill is connected to the LAN and the step of receiving a request further comprises the steps of,
determining if the chosen game is unavailable;
if not available, directing the player to other available games;
and, contacting the game console through the web hosting server once the game becomes available if the player chooses to wait for the first chosen game to become available.

16. A method as defined in claim 13 wherein the step of providing visual feed back includes the step of:
displaying a virtual graphic plot on the console monitor of the operating elements of the mechanical game of skill to provide the player with exact positioning of such elements.

17. a method as defined in claim 13 wherein the step of converting the signal format comprises the steps of:
receiving the command sequence through a Skill Game Controller (SGC); and
passing the digital command sequence to a electrical signal conditioning unit (ESCU).
